(19) United States
(12) Patent Application Publication
(10) Pub. No.: US 2026/0340835 A1
(43) Pub. Date: Oct. 29, 2026

(54) METHOD FOR PROCESSING ABDOMINAL MEDICAL IMAGE

(71) Applicant: The First Affiliated Hospital of Guangzhou Medical University (Guangzhou Respiratory Center), Guangzhou (CN)

(72) Inventors: Shuhong ZHENG, Guangzhou (CN); Yingying BAO, Guangzhou (CN); Miaomiao CHEN, Guangzhou (CN); Yingjian YANG, Shenzhen (CN); Xinchun LI, Guangzhou (CN); Xian LI, Guangzhou (CN); Lisheng CHEN, Guangzhou (CN); Tianqi WU, Shenzhen (CN); Jie ZHENG, Shenzhen (CN); Peng GUO, Shenzhen (CN)

(73) Assignee: The First Affiliated Hospital of Guangzhou Medical University (Guangzhou Respiratory Center), Guangzhou (CN)

(21) Appl. No.: 19/654,514

(22) Filed: Apr. 22, 2026

(30) Foreign Application Priority Data
Apr. 27, 2025 (CN) 202510544329.2

(51) Int. Cl. G06T 7/11; G06T 7/00

(52) U.S. Cl. CPC G06T 7/11; G06T 7/0012; G06T 2207/10081; G06T 2207/20081; G06T 2207/20221; G06T 2207/30084

(57) ABSTRACT

The technique can be used for abdominal image processing. Multi-mask label fusion images corresponding to dual-energy abdominal training images and representing a kidney, ureter, bladder, and calculus, are used for training a pre-set segmentation network, so as to obtain a corresponding calculus segmentation model. A calculus in the kidney, ureter, and bladder in a dual-energy abdominal image is segmented so as to obtain a calculus mask image.

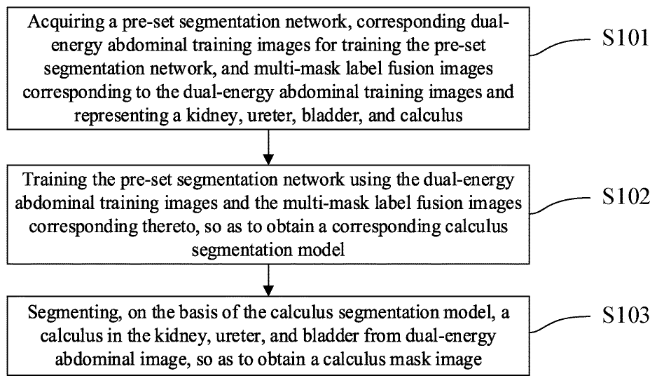

### CROSS-REFERENCE TO RELATED APPLICATIONS

The application claims priority to Chinese patent application No. 202510544329.2, filed on Apr. 27, 2025, the entire contents of which are incorporated herein by reference.

### TECHNICAL FIELD

The present disclosure relates to the technical field of abdominal image processing, and in particular, to a method for processing an abdominal medical image.

### BACKGROUND

The urinary calculus is a common urinary system disease. The urinary calculus can occur in any part of a kidney, bladder, ureter, and urethra, among which kidney, bladder, and ureter calculi are the most common. Clinical manifestations vary depending on the calculus positions. The early diagnosis and accurate measurement are crucial for formulating effective treatment plans.

### SUMMARY

The embodiments of the present disclosure provide a method for processing an abdominal medical image, comprising:

acquiring a pre-set segmentation network, corresponding dual-energy abdominal training images for training the pre-set segmentation network, and multi-mask label fusion images corresponding to the dual-energy abdominal training images and representing a kidney, ureter, bladder, and calculus, wherein constructing the multi-mask label fusion images representing the kidney, ureter, bladder, and calculus comprises: acquiring an organ mask label image corresponding to at least one organ of the kidney, ureter, and bladder and a calculus mask label image in the organ from the dual-energy abdominal training images; generating, on the basis of an organ mask value corresponding to the organ mask label image and a spatial position of the organ corresponding to the organ mask label value, as well as a calculus mask value corresponding to the calculus mask label image and a second spatial position corresponding to the calculus mask value. multi-mask label fusion images corresponding to the dual-energy abdominal training images;

training the pre-set segmentation network using the dual-energy abdominal training images and the multi-mask label fusion images corresponding thereto, so as to obtain a corresponding calculus segmentation model; and segmenting, on the basis of the calculus segmentation model, a calculus in the kidney, ureter, and bladder from dual-energy abdominal image, so as to obtain a calculus mask image.

It is to be understood that both the foregoing general description and the following detailed description are exemplary and explanatory only and are not restrictive of the present disclosure.

Further features and aspects of the present disclosure will become apparent from the following detailed description of exemplary embodiments with reference to the accompanying drawings.

### BRIEF DESCRIPTION OF DRAWINGS

The accompanying drawings herein illustrate embodiments consistent with the present disclosure and, together with the description, serve to explain the technical solutions of the present disclosure.

The figure shows a flow chart of a method for processing an abdominal medical image according to an embodiment of the present disclosure.

### DETAILED DESCRIPTION OF THE EMBODIMENTS

Various exemplary embodiments, features, and aspects of the present disclosure will be described in detail below with reference to the accompanying drawings. The same reference numbers in the drawings represent elements with the same or similar functions. While various aspects of the embodiments are shown in the drawings, the drawings are not necessarily drawn to scale unless otherwise specified.

The word “exemplary” is used herein to mean “as an example, instance, or illustration.” Any embodiment described herein as “exemplary” is not necessarily to be construed as preferred or advantageous over other embodiments.

The term “and/or” herein merely describes an association relationship of associated objects, indicating that three relationships may exist. For example, A and/or B, may represent: A alone, both A and B, and B alone. In addition, the term “at least one” as used herein refers to any one of multiple elements or any combination of at least two of multiple elements. For example, comprising at least one of A, B, and C may represent comprising any one or more elements selected from a set consisting of A, B, and C.

In addition, numerous specific details are provided in the following detailed description in order to better describe the present disclosure. Those skilled in the art should appreciate that the present disclosure may be practiced without some of these specific details. In some instances, the methods, means, elements, and circuits which are well-known to those skilled in the art have not been described in detail so as to highlight the substance of the present disclosure.

It can be understood that the above-mentioned embodiments of various methods for processing an abdominal medical image mentioned in the present disclosure may be combined with each other to form combined embodiments without violating the principle and logic, which are not repeated herein for brevity.

The figure shows a flow chart of a method for processing an abdominal medical image according to an embodiment of the present disclosure. As shown in the figure, the method for processing an abdominal medical image comprises: step S101: acquiring a pre-set segmentation network, corresponding dual-energy abdominal training images for training the pre-set segmentation network, and multi-mask label fusion images corresponding to the dual-energy abdominal training images and representing a kidney, ureter, bladder, and calculus; step S102: training the pre-set segmentation network using the dual-energy abdominal training images and the multi-mask label fusion images corresponding thereto, so as to obtain a corresponding calculus segmentation model; and step S103: segmenting, on the basis of the calculus segmentation model, a calculus in the kidney, ureter, and bladder from dual-energy abdominal image, so as to obtain a calculus mask image. The technical problem that anatomical structure information of the spatial positions of the kidney, ureter, bladder, and calculus is not fully utilized at present, thereby lacking the synergistic effect of such anatomical structure information of the kidney, ureter, bladder, and calculus is solved.

Step S101: acquiring a pre-set segmentation network, corresponding dual-energy abdominal training images for training the pre-set segmentation network, and multi-mask label fusion images corresponding to the dual-energy abdominal training images and representing a kidney, ureter, bladder, calculus.

In the embodiments of the present disclosure and other possible embodiments, the abdominal region of a patient is scanned by using a spectral CT equipment (a dual-energy CT equipment, a spectral CT equipment) to obtain a three-dimensional dual-energy abdominal image (a dual-energy abdominal image/dual-energy spectral abdominal image/dual-energy abdominal CT image/dual-energy spectral abdominal CT image/spectral abdominal image/spectral abdominal CT image).

In the embodiments of the present disclosure and other possible embodiments, a dual-energy digital X-ray machine is used to shoot the abdominal region of a patient, and a two-dimensional dual-energy abdominal image (dual-energy abdominal image/dual-energy abdominal X-ray image) is obtained.

In the embodiments of the present disclosure and other possible embodiments, the dual-energy abdominal training image may be configured to be a three-dimensional dual-energy abdominal image (dual-energy abdominal image/dual-energy spectral abdominal image/dual-energy abdominal CT image/dual-energy spectral abdominal CT image/spectral abdominal image/spectral abdominal CT image) or a two-dimensional dual-energy abdominal image (dual-energy abdominal image/dual-energy abdominal X-ray image).

In the embodiments of the present disclosure and other possible embodiments, the pre-set segmentation network is configured to be one or more of segmentation networks such as Unet, ResUnet, Unet++, ResUnet++, nnUnet, SegNet, PSPNet, DeepLab, RefineNet, Medformer, or improved segmentation networks thereof.

In an embodiment of the present disclosure, a method for constructing multi-mask label fusion images respectively representing a kidney, bladder, ureter, and calculus, comprises: acquiring an organ mask label image corresponding to at least one organ of the kidney, ureter, and bladder and a calculus mask label image in the organ from the dual-energy abdominal training images; and generating, on the basis of the organ mask label image and the calculus mask label image, multi-mask label fusion images corresponding to the dual-energy abdominal training images.

In an embodiment of the present disclosure, the method for generating, on the basis of the organ mask label image and the calculus mask label image, multi-mask label fusion images corresponding to the dual-energy abdominal training images, comprises: generating, on the basis of an organ mask value corresponding to the organ mask label image and a spatial position of the organ corresponding to the organ mask label value, as well as a calculus mask value corresponding to the calculus mask label image and a second spatial position corresponding to the calculus mask value. multi-mask label fusion images corresponding to the dual-energy abdominal training images; and/or, in an embodiment of the present disclosure, before said acquiring an organ mask label image corresponding to at least one organ of the kidney, ureter, and bladder and a calculus mask label image in the organ from the dual-energy abdominal training images, the calculus mask label image is determined on the basis of an iodine-based image/calcium image corresponding to the dual-energy abdominal training images, and the organ mask label image is determined on the basis of a water-based image/soft tissue image corresponding to the dual-energy abdominal training images.

In the embodiments of the present disclosure and other possible embodiments, the method for determining, on the basis of an iodine-based image/calcium image corresponding to the dual-energy abdominal training images, the calculus mask label image, comprises: delineating a calculus on the iodine-based image/calcium image corresponding to the dual-energy abdominal training image, and determining the calculus mask label image.

In the embodiments of the present disclosure and other possible embodiments, the method for determining, on the basis images of a water-based image/soft tissue image corresponding to the dual-energy abdominal training images, the organ mask label image, comprises: delineating an organ on the water-based image/soft tissue image corresponding to the dual-energy abdominal training image, and determining the organ mask label image.

In the embodiments of the present disclosure and other possible embodiments, the method for generating, on the basis of an organ mask value corresponding to the organ mask label image and a spatial position of the organ corresponding to the organ mask value, as well as a calculus mask value corresponding to the calculus mask label image and a spatial position of the calculus corresponding to the calculus mask value, multi-mask label fusion images corresponding to the dual-energy abdominal training images, comprises: determining the spatial position of the organ corresponding to the organ mask value in the organ mask label image and the spatial position of the calculus corresponding to the calculus mask value in the calculus mask image, respectively; if the spatial position of the organ overlaps with the spatial position of the calculus, then updating the mask value corresponding to the overlapping spatial position to be the calculus mask value corresponding to the spatial position of the calculus; otherwise, retaining the organ mask value corresponding to the spatial position of the organ, and generating multi-mask label fusion images corresponding to the dual-energy abdominal training images.

In the embodiments of the present disclosure and other possible embodiments, before said determining the spatial position of the organ corresponding to the organ mask value in the organ mask label image and the spatial position of the calculus corresponding to the calculus mask value in the calculus mask image, respectively, the method further comprises: if the number corresponding to the calculus mask images is greater than 1, then acquiring the spatial positions of the calculi corresponding to the plurality of calculus mask images, respectively; determining whether spatial position overlapping exists among the spatial positions of the calculi corresponding to the plurality of calculus mask images; if spatial position overlapping exists, then respectively generating a multi-mask label fusion image for each calculus and its corresponding organ corresponding to the overlapped spatial position, and jointly generating multi-mask label fusion images for calculi and their corresponding organs corresponding to non-overlapped spatial positions; otherwise, jointly generating multi-mask label fusion images corresponding to all calculi and their corresponding organs.

Step S102: training the pre-set segmentation network using the dual-energy abdominal training images and the multi-mask label fusion images corresponding thereto, so as to obtain a corresponding calculus segmentation model.

In an embodiment of the present disclosure, the method for training the pre-set segmentation network using the dual-energy abdominal training images and the multi-mask label fusion images corresponding thereto, so as to obtain a corresponding calculus segmentation model, comprises: acquiring a set loss value corresponding to the calculus segmentation model; and in the process of training the pre-set segmentation network using the dual-energy abdominal training images and the multi-mask label fusion images corresponding thereto, if the loss value corresponding to the calculus segmentation model is smaller than or equal to the set loss value, stopping the training of the pre-set segmentation network, and obtaining the corresponding calculus segmentation model.

In the embodiments of the present disclosure and other possible embodiments, the process of training the pre-set segmentation network using the dual-energy abdominal training images and the multi-mask label fusion images corresponding thereto, comprises: acquiring an organ loss function corresponding to the organ and an organ loss weight value corresponding thereto, and a calculus loss function corresponding to the calculus and its corresponding calculus loss weight value which is smaller than the organ loss weight value; in the process of training the pre-set segmentation network, if the organ loss value corresponding to the organ loss function is smaller than a first set loss value, and/or the total loss value corresponding to the organ loss function and the calculus loss function is smaller than a second set loss value, then in each training process of the preset segmentation network of subsequent training, increasing and adjusting the calculus loss weight value according to a set ratio, so as to obtain an adjusted calculus loss weight value; determining, according to the adjusted calculus loss weight value, an adjusted organ loss weight value corresponding to the organ loss weight value; calculating, on the basis of the adjusted calculus loss weight value and the adjusted organ loss weight value, a calculus loss value corresponding to the calculus loss function and the total loss value corresponding to the organ loss function and the calculus loss function; and if the calculus loss value is smaller than a third set loss value, and/or the total loss value corresponding to the organ loss function and the calculus loss function is smaller than a fourth set loss value, stopping the training of the pre-set segmentation network.

In the embodiments of the present disclosure and other possible embodiments, the method for determining, according to the adjusted calculus loss weight value, an adjusted organ loss weight value corresponding to the organ loss weight value, comprises: acquiring a set configuration value corresponding to the sum of the organ loss weight value and the calculus loss weight value; and determining the adjusted organ loss weight value corresponding to the organ loss weight value by subtracting the adjusted calculus loss weight value from the set configuration value, wherein the set configuration value corresponding to the sum of the organ loss weight value and the calculus loss weight value is configured to be 1.

In the embodiments of the present disclosure and other possible embodiments, the organ loss function and the calculus loss function are respectively configured to be one or more of a cross-entropy loss function, a Dice loss function, a Focal loss function, a Tversky loss function, and an IoU loss function.

Step S103: segmenting, on the basis of the calculus segmentation model, a calculus in the kidney, ureter, and bladder from dual-energy abdominal image, so as to obtain a calculus mask image.

In an embodiment of the present disclosure, the method for processing an abdominal medical image further comprises: extracting corresponding calculus information on the basis of the dual-energy abdominal image and/or calculus mask image, wherein the calculus information is configured to be information of one or more of a calculus position, a calculus shape, a calculus gray-scale value, a long diameter and a short diameter corresponding to the calculus, a calculus area, and a calculus volume.

In an embodiment of the present disclosure, the calculus position corresponding to the calculus information is determined on the basis of a kidney and/or ureter and/or bladder mask image corresponding to the dual-energy abdominal image and the calculus mask image.

In the embodiments of the present disclosure and other possible embodiments, the method for determining, on the basis of a kidney and/or ureter and/or bladder mask image corresponding to the dual-energy abdominal image and the calculus mask image, the calculus position corresponding to the calculus information, comprises: segmenting a kidney and/or ureter and/or a bladder from the dual-energy abdominal image, so as to obtain a kidney and/or ureter and/or bladder mask image(s); configuring, according to the kidney and/or ureter and/or bladder mask image(s), a kidney and/or ureter and/or bladder mask(s) among the kidney and/or ureter and/or bladder mask image(s) to be a left kidney and/or ureter and/or bladder mask(s), and a right kidney and/or ureter and/or bladder mask(s); and determining, on the basis of a spatial positional relationship between a calculus mask in the calculus mask image and the left kidney and/or ureter and/or bladder mask(s), and the right kidney and/or ureter and/or bladder mask(s) among the kidney and/or ureter and/or bladder mask image(s), a calculus position corresponding to each calculus type.

In the embodiments of the present disclosure and other possible embodiments, the method for determining, on the basis of a spatial positional relationship between a calculus mask in the calculus mask image and the left kidney and/or ureter and/or bladder mask(s), and the right kidney and/or ureter and/or bladder mask(s) among the kidney and/or ureter and/or bladder mask image(s), a calculus position corresponding to each calculus type, comprises: if the dual-energy abdominal image is configured to be a three-dimensional dual-energy abdominal CT image, extracting a plurality of two-dimensional slice calculus mask images corresponding to each calculus type from the calculus mask image; if the calculus mask spatial positions corresponding to the plurality of two-dimensional slice calculus mask images are within the left kidney and/or ureter and/or bladder mask spatial positions of the two-dimensional slice calculus mask images of corresponding slices of the kidney and/or ureter and/or bladder mask images, then configuring the calculus corresponding to the calculus mask spatial positions to be a left kidney and/or ureter and/or bladder calculus; and if the calculus mask spatial positions corresponding to the plurality of two-dimensional slice calculus mask images are within the right kidney and/or ureter and/or bladder mask spatial positions of the two-dimensional slice calculus mask images of corresponding slices of the kidney and/or ureter and/or bladder mask images, then configuring the calculus corresponding to the calculus mask spatial positions to be a right kidney and/or ureter and/or bladder calculus.

In the embodiments of the present disclosure and other possible embodiments, the method for determining, on the basis of a spatial positional relationship between a calculus mask in the calculus mask image and the left kidney and/or ureter and/or bladder mask(s), and the right kidney and/or ureter and/or bladder mask(s) among the kidney and/or ureter and/or bladder mask image(s), a calculus position corresponding to each calculus type, comprises: if the dual-energy abdominal image is configured to be a two-dimensional dual-energy abdominal X-ray image, performing organ segmentation on the dual-energy abdominal image, so as to obtain a two-dimensional organ mask image; configuring, according to the two-dimensional organ mask image, organ masks in the two-dimensional organ mask image to be a left organ mask and a right organ mask; and determining, on the basis of a spatial positional relationship between a calculus mask in the calculus mask image and the left organ mask and right organ mask in the two-dimensional organ mask image, a calculus position corresponding to each calculus type.

In the embodiments of the present disclosure and other possible embodiments, the method for determining, on the basis of a spatial positional relationship between a calculus mask in the calculus mask image and the left organ mask and right organ mask in the organ mask image, a calculus position corresponding to each calculus type, comprises: if the spatial position of the calculus mask corresponding to the calculus mask image is within the spatial position of the left organ mask corresponding to the organ mask image, then configuring the calculus corresponding to the spatial position of the calculus mask to be a left organ calculus; and if the spatial position of the calculus mask corresponding to the calculus mask image is within the spatial position of the right organ mask corresponding to the organ mask image, then configuring the calculus corresponding to the spatial position of the calculus mask to be a right organ calculus.

In an embodiment of the present disclosure, a calculus gray-scale value corresponding to the calculus information is determined on the basis of the dual-energy abdominal image and the calculus mask image corresponding thereto.

In the embodiments of the present disclosure and other possible embodiments, the method for determining, on the basis of the dual-energy abdominal image and the calculus mask image corresponding thereto, a calculus gray-scale value corresponding to the calculus information, comprises: if the dual-energy abdominal image is configured to be a three-dimensional dual-energy abdominal CT image, extracting, on the basis of each two-dimensional slice dual-energy abdominal image of the dual-energy abdominal image and a two-dimensional slice calculus mask image of a calculus mask image of a corresponding slice thereof, a calculus image with an original gray-scale value from the dual-energy abdominal image, respectively; and respectively calculating an average gray-scale value corresponding to each calculus type in the calculus mask image, and determining a calculus gray-scale value corresponding to each calculus type.

In the embodiments of the present disclosure and other possible embodiments, the method for extracting, on the basis of each two-dimensional slice dual-energy abdominal image of the dual-energy abdominal image and a two-dimensional slice calculus mask image of a calculus mask image of a corresponding slice thereof, a calculus image with an original gray-scale value from the dual-energy abdominal image, respectively, comprises: performing a multiplication operation on each two-dimensional slice dual-energy abdominal image of the dual-energy abdominal image and a two-dimensional slice calculus mask image of a calculus mask image of a corresponding slice thereof, so as to obtain a calculus gray-scale value image; and performing, on the basis of the calculus gray-scale value image and the mask value and calculus spatial position corresponding to each calculus type in the two-dimensional slice calculus mask image of the calculus mask image of a corresponding slice thereof, gray-scale value restoration on the calculus gray-scale value image, so as to obtain a calculus image with an original gray-scale value.

In the embodiments of the present disclosure and other possible embodiments, the method for performing, on the basis of the calculus gray-scale value image and the mask value and calculus spatial position corresponding to each calculus type in the two-dimensional slice calculus mask image of the calculus mask image of a corresponding slice thereof, gray-scale value restoration on the calculus gray-scale value image, so as to obtain a calculus image with an original gray-scale value, comprises: extracting the mask value and calculus spatial position corresponding to each calculus type in the two-dimensional slice calculus mask image of the calculus mask image, respectively; performing, on the basis of the calculus spatial position corresponding to each calculus type, calculus type spatial positioning on the calculus gray-scale value image, respectively, so as to obtain a spatial position positioning image corresponding to each calculus type of a two-dimensional slice calculus gray-scale value image of the calculus gray-scale value image; and dividing the spatial position positioning image corresponding to each calculus type of the two-dimensional slice calculus gray-scale value image in the calculus gray-scale value image by the mask value corresponding to the calculus spatial position, so as to obtain a calculus image with an original gray-scale value.

In the embodiments of the present disclosure and other possible embodiments, if the dual-energy abdominal image is configured to be a two-dimensional dual-energy abdominal X-ray image, then a calculus image with an original gray-scale value is extracted from the dual-energy abdominal image on the basis of the dual-energy abdominal image and a calculus mask image corresponding thereto; and an average gray-scale value corresponding to each calculus type in the calculus mask image is calculated, and a calculus gray-scale value corresponding to each calculus type is determined.

In an embodiment of the present disclosure, on the basis of the calculus mask image, one or more of the following items of information corresponding to the calculus information are determined: a calculus shape, a long diameter and a short diameter of the calculus, and a calculus volume.

In the embodiments of the present disclosure and other possible embodiments, the method for determining, on the basis of the calculus mask image, one or more of the following items of information corresponding to the calculus information: a calculus shape, a long diameter and a short diameter of the calculus, and a calculus volume, comprises: respectively calculating the calculus area corresponding to each calculus type in each two-dimensional slice calculus mask image of a calculus mask image corresponding to the dual-energy abdominal image; obtaining a plurality of calculus areas; respectively calculating a long diameter and a short diameter corresponding to the largest calculus area among the plurality of calculus areas corresponding to each calculus type, so as to obtain a long diameter and a short diameter corresponding to each calculus type; and/or, respectively performing edge detection on the calculus corresponding to each calculus type on the calculus mask image corresponding to the dual-energy abdominal image, so as to obtain a calculus edge mask line; respectively fitting the calculus edge mask line corresponding to each calculus type, so as to obtain the calculus shape corresponding to each calculus type; and/or, respectively reconstructing a mask image corresponding to each calculus type in the calculus mask image corresponding to the dual-energy abdominal image, so as to obtain the calculus volume corresponding to each calculus type.

In an embodiment of the present disclosure, the method for processing an abdominal medical image further comprises: if the dual-energy abdominal image is configured to be a three-dimensional dual-energy abdominal CT image, then identifying, on the basis of an atomic number image of a urinary calculus corresponding to the dual-energy abdominal image, a calculus type corresponding to the calculus information. This is to solve the technical problem that it is difficult to distinguish or identify mixed urinary calculi of different compositions, thereby failing to meet the clinical diagnostic requirement that mixed-composition calculi are more frequent than single-composition calculi.

In the embodiments of the present disclosure and other possible embodiments, the abdominal region of a patient is scanned by using a spectral CT equipment (a dual-energy CT equipment, a spectral CT equipment) to obtain a three-dimensional dual-energy abdominal image (a dual-energy abdominal image/dual-energy spectral abdominal image/dual-energy abdominal CT image/dual-energy spectral abdominal CT image/spectral abdominal image/spectral abdominal CT image).

In the embodiments of the present disclosure and other possible embodiments, the spectral CT equipment (dual-energy CT equipment, and spectral CT equipment), i.e., a rapid tube voltage switch dual-source CT equipment, adopts an instantaneous kVp switching technique to complete high and low monoenergetic switching within an extremely short time (<0.25 ms), realizing “three sameness” of dual-energy (same time, same orientation, and same source). It overcomes the defects of dual-tube dual-source CT, thereby avoiding a slight angular difference between scanning planes of two tubes, and improving the accuracy of acquiring data so as to provide a superior CT scanning image.

In the embodiments of the present disclosure and other possible embodiments, spectral CT scanning and three-dimensional reconstruction can not only clearly demonstrate the density and morphology of renal parenchyma, the orientation and contour of renal pelvis and calyces, the course and lumen of ureter, as well as the bladder wall and intraluminal conditions, but also show the morphology and positions of a renal calculus and the renal pelvis and calyces, and further measure the volumes of the calculus and the renal pelvis and calyces. The imaging quality is far superior to that of three-dimensional multi-planar reconstruction of conventional CT. In particular, the effective atomic number (Zeff value) of spectral CT can be used to analyze the composition characteristics of the renal calculus, show numerical differences in different regions, and clarify the specific spatial distribution of different compositions in a mixed calculus based on these differences.

In the embodiments of the present disclosure and other possible embodiments, the method for identifying, on the basis of an atomic number image of a urinary calculus corresponding to the dual-energy abdominal image, a calculus type corresponding to the calculus information, comprises: if the dual-energy abdominal image is configured to be a three-dimensional dual-energy abdominal CT image, acquiring an atomic number image of a urinary calculus corresponding to the dual-energy abdominal image; and identifying, on the basis of the atomic number image of the urinary calculus, the calculus type corresponding to the dual-energy abdominal image.

In the embodiments of the present disclosure and other possible embodiments, the method for identifying, on the basis of the atomic number image of the urinary calculus, the calculus type corresponding to the dual-energy abdominal image, comprises: extracting a plurality of composition percentages of corresponding peaks of a plurality of histograms corresponding to effective atomic numbers in the atomic number image of the urinary calculus; and identifying, on the basis of the plurality of composition percentages corresponding to the plurality of histograms and a plurality of set calculus type composition percentage ranges, the calculus type corresponding to the dual-energy abdominal image.

In the embodiments of the present disclosure and other possible embodiments, the method for extracting a plurality of composition percentages of corresponding peaks of a plurality of histograms corresponding to effective atomic numbers in the atomic number image of the urinary calculus, comprises: acquiring a set histogram color and/or a set histogram width; extracting, according to the set histogram color and/or set histogram width, a plurality of histograms corresponding to effective atomic numbers, which satisfy the set histogram color and/or set histogram width, in the atomic number image of the urinary calculus; and determining, according to the plurality of corresponding histograms, which satisfy the set histogram color and/or set histogram width, in the atomic number image of the urinary calculus, a plurality of composition percentages of corresponding peaks of the plurality of histograms.

In the embodiments of the present disclosure and other possible embodiments, those skilled in the art may configure the set histogram color and/or set histogram width according to actual needs. For example, the set histogram color is configured to be yellow.

In the embodiments of the present disclosure and other possible embodiments, before said extracting a plurality of histograms corresponding to effective atomic numbers to the embodiment of the and other possible atomic number image of the urinary calculus, or extracting a plurality of histograms corresponding to effective atomic numbers, which satisfy the set histogram color and/or set histogram width, in the atomic number image of the urinary calculus, the atomic number image of the urinary calculus is corrected to obtain a corrected atomic number image of the urinary calculus; and a plurality of composition percentages of corresponding peaks of a plurality of histograms corresponding to effective atomic numbers in the corrected atomic number image of the urinary calculus are extracted, or a plurality of composition percentages of corresponding peaks of a plurality of histograms corresponding to effective atomic numbers which satisfy the set histogram color and/or set histogram width in the corrected atomic number image of the urinary calculus are extracted.

In the embodiments of the present disclosure and other possible embodiments, the method for correcting the atomic number image of the urinary calculus to obtain a corrected atomic number image of the urinary calculus, comprises: performing at least one correction processing operation such as angle adjustment, contrast enhancement, and scaling on the atomic number image of the urinary calculus to obtain a corrected atomic number image of the urinary calculus, so as to facilitate subsequent extraction of a plurality of histograms corresponding to the effective atomic numbers.

In the embodiments of the present disclosure and other possible embodiments, an optical character recognition technique is used to extract a plurality of composition percentages of corresponding peaks of a plurality of histograms corresponding to effective atomic numbers in the atomic number image of the urinary calculus; or the optical character recognition technique is used to extract a plurality of composition percentages of corresponding peaks of a plurality of histograms corresponding to effective atomic numbers which satisfy the set histogram color and/or set histogram width in the corrected atomic number image of the urinary calculus.

In the embodiments of the present disclosure and other possible embodiments, optical character recognition (OCR) is a computer vision technique that recognizes and extracts text content from an image through image processing and machine learning algorithms, and converts same into a machine-readable and editable text format.

In the embodiments of the present disclosure and other possible embodiments, the method for identifying, on the basis of the plurality of composition percentages corresponding to the plurality of histograms and a plurality of set calculus type composition percentage ranges, the calculus type corresponding to the dual-energy abdominal image, comprises: acquiring a set composition percentage that is smaller than the range minimum value in the set calculus type composition percentage range; if the composition percentages corresponding to a plurality of histograms are smaller than the set composition percentage, then deleting the composition percentage which is smaller than the set composition percentage from the plurality of composition percentages corresponding to the plurality of histograms; otherwise, retaining the composition percentages which are greater than or equal to the set composition percentage; and identifying, on the basis of the retained plurality of composition percentages and a plurality of set calculus type composition percentage ranges, the calculus type corresponding to the dual-energy abdominal image.

In the embodiments of the present disclosure and other possible embodiments, those skilled in the art may configure the set composition percentage that is smaller than the range minimum value in the set calculus type composition percentage range according to actual needs. For example, the set composition percentage that is smaller than the range minimum value in the set calculus type composition percentage range is configured to be 5%.

In the embodiments of the present disclosure and other possible embodiments, the implementation of OCR requires calling the API of the GOT_OCR2 tool and setting its parameters such as language and text box positioning; and the identification of atomic number peaks and morphological calculation require using the NumPy, SciPy, or OpenCV library of Python to extract a plurality of composition percentages of corresponding peaks of a plurality of histograms corresponding to effective atomic numbers in the atomic number image of the urinary calculus, or a plurality of composition percentages of corresponding peaks of a plurality of histograms corresponding to effective atomic numbers which satisfy the set histogram color and/or set histogram width in the atomic number image of the urinary calculus.

In the embodiments of the present disclosure and other possible embodiments, the method for identifying, on the basis of the plurality of composition percentages corresponding to the plurality of histograms and a plurality of set calculus type composition percentage ranges, the calculus type corresponding to the dual-energy abdominal image, comprises: acquiring a set composition percentage that is smaller than the range minimum value in the set calculus type composition percentage range; if the composition percentages corresponding to a plurality of histograms are smaller than the set composition percentage, then deleting the composition percentage which is smaller than the set composition percentage from the plurality of composition percentages corresponding to the plurality of histograms; otherwise, retaining the composition percentages which are greater than or equal to the set composition percentage; and identifying, on the basis of the retained plurality of composition percentages and a plurality of set calculus type composition percentage ranges, the calculus type corresponding to the dual-energy abdominal image.

In the embodiments of the present disclosure and other possible embodiments, the method for identifying, on the basis of the plurality of composition percentages corresponding to the plurality of histograms and a plurality of set calculus type composition percentage ranges, the calculus type corresponding to the dual-energy abdominal image, further comprises: if composition percentage ranges of set calculus types corresponding to at least two of the plurality of composition percentages corresponding to the plurality of histograms have an overlapping range, then acquiring an iodine-based image corresponding to the dual-energy abdominal image; and identifying, on the basis of the iodine-based image corresponding to the dual-energy abdominal image, the calculus type corresponding to the overlapping range.

In the embodiments of the present disclosure and other possible embodiments, the method for identifying, on the basis of the iodine-based image corresponding to the dual-energy abdominal image, the calculus type corresponding to the overlapping range, comprises: determining a calculus gray-scale value corresponding to the iodine-based image corresponding to the dual-energy abdominal image; respectively calculating an average gray-scale value and a uniformity corresponding to the calculus gray-scale value; if the average gray-scale value is greater than a set average gray-scale value and the uniformity is greater than a set uniformity, then configuring the calculus type to be calcium oxalate dihydrate calculus; otherwise, configuring the calculus type to be struvite calculus or carbonate apatite calculus.

In the embodiments of the present disclosure and other possible embodiments, the plurality of composition percentage ranges of set calculus types comprise: one or more of the following: a composition percentage range of uric acid calculus, a composition percentage range of calcium oxalate monohydrate calculus, a composition percentage range of calcium oxalate dihydrate calculus, a composition percentage range of carbonate apatite calculus, a composition percentage range of calcium carbonate phosphate calculus, and a composition percentage range of struvite calculus.

In the embodiments of the present disclosure and other possible embodiments, those skilled in the art may configure the set average gray-scale value and the set uniformity according to actual needs.

In the embodiments of the present disclosure and other possible embodiments, uniformity=(maximum value−minimum value)/(2*average value)×100%, where the maximum value represents the maximum value corresponding to the calculus gray-scale value, the minimum value represents the minimum value corresponding to the calculus gray-scale value, and the average value represents the average gray-scale value corresponding to the calculus gray-scale value.

In the embodiments of the present disclosure and other possible embodiments, the composition percentage range of uric acid calculus is configured to be 6.5-10.5, the composition percentage range of calcium oxalate monohydrate calculus is configured to be 13.3-14.0, the composition percentage range of calcium oxalate dihydrate calculus is configured to be 12.0-13.3, the composition percentage range of carbonate apatite calculus is configured to be 14.0-15.0, the composition percentage range of calcium carbonate phosphate calculus is configured to be greater than 12.5, and the composition percentage range of struvite calculus is configured to be smaller than 12.5.

In the embodiments of the present disclosure and other possible embodiments, the Zeff peak (composition percentage range) of uric acid calculus is 6.5-10.5; the Zeff peak of calcium oxalate monohydrate calculus is 13.3-14.0; the Zeff peak of calcium oxalate dihydrate calculus is 12.0-13.3; the Zeff peak of carbonate apatite calculus is 14.0-15.0; the Zeff peak of calcium carbonate phosphate calculus is greater than 12.5, and the CT value images all show inhomogeneous density; and the Zeff peak of struvite calculus is smaller than 12.5, and the CT value images all show inhomogeneous density.

In the embodiments of the present disclosure and other possible embodiments, the method for identifying, on the basis of the plurality of composition percentages corresponding to the plurality of histograms and a plurality of set calculus type composition percentage ranges, the calculus type corresponding to the dual-energy abdominal image, comprises: constructing a calculus composition comparison table according to the plurality of set composition percentage ranges of calculus types; and performing, on the basis of the calculus composition comparison table, a table lookup and comparison operation on the plurality of composition percentages corresponding to the plurality of histograms, so as to identify the calculus type corresponding to the dual-energy abdominal image.

The execution subject of the method for processing an abdominal medical image may be an apparatus/system for processing an abdominal medical image. For example, the method for processing an abdominal medical image may be executed by a terminal device, or a server, or other processing devices, wherein the terminal device may be a user equipment (UE), a mobile device, a user terminal, a terminal, a cellular phone, a cordless telephone, a personal digital assistant (PDA), a handheld device, a computing device, a vehicle-mounted device, a wearable device, or the like. In some possible implementations, the method for processing an abdominal medical image may be implemented by a processor calling computer-readable instructions stored in a memory.

It will be understood by those skilled in the art that, in the method for processing an abdominal medical image in the detailed description described above, the writing order of the steps does not imply a strict execution order or constitute any limitation on the implementation process, and the specific execution order of each step shall be determined based on its function and possible internal logic.

Various embodiments of the present disclosure have been described above. The description above is exemplary, not exhaustive, and is not limited to the disclosed embodiments. Many modifications and variations will be apparent to those of ordinary skill in the art without departing from the scope and spirit of the described embodiments. The terminology used herein is chosen to best explain the principles of the embodiments, their practical application, or improvements over the technologies in the market, or to enable other persons of ordinary skill in the art to understand the embodiments disclosed herein.

What is claimed is:

1. A method for processing an abdominal medical image, the method comprising:
acquiring a pre-set segmentation network, corresponding dual-energy abdominal training images for training the pre-set segmentation network, and multi-mask label fusion images corresponding to the dual-energy abdominal training images and representing a kidney, ureter, bladder, and calculus; constructing the multi-mask label fusion images representing the kidney, ureter, bladder, and calculus, comprising: acquiring an organ mask label image corresponding to at least one organ of the kidney, ureter, and bladder and a calculus mask label image in the organ from the dual-energy abdominal training images; and generating, on the basis of an organ mask value corresponding to the organ mask label image and a spatial position of the organ corresponding to the organ mask label value, as well as a calculus mask value corresponding to the calculus mask label image and a second spatial position corresponding to the calculus mask value, multi-mask label fusion images corresponding to the dual-energy abdominal training images;
training the pre-set segmentation network using the dual-energy abdominal training images and the multi-mask label fusion images corresponding thereto, so as to obtain a corresponding calculus segmentation model; and
segmenting, on the basis of the calculus segmentation model, a calculus in the kidney, ureter, and bladder from dual-energy abdominal image, so as to obtain a calculus mask image.

2. The method of claim 1, before said acquiring an organ mask label image corresponding to at least one organ of the kidney, ureter, and bladder and a calculus mask label image in the organ from the dual-energy abdominal training images, the calculus mask label image is determined on the basis of an iodine-based image/calcium image corresponding to the dual-energy abdominal training images, and the organ mask label image is determined on the basis of a water-based image/soft tissue image corresponding to the dual-energy abdominal training images.

3. The method of claim 1, training the pre-set segmentation network using the dual-energy abdominal training images and the multi-mask label fusion images corresponding thereto, so as to obtain a corresponding calculus segmentation model, comprising:
acquiring a set loss value corresponding to the calculus segmentation model; and
in the process of training the pre-set segmentation network using the dual-energy abdominal training images and the multi-mask label fusion images corresponding thereto, if the loss value corresponding to the calculus segmentation model is smaller than or equal to the set loss value, stopping the training of the pre-set segmentation network, and obtaining the corresponding calculus segmentation model.

4. The method of claim 1, further comprising:
extracting corresponding calculus information on the basis of the dual-energy abdominal image and/or the calculus mask image, wherein the calculus information is configured to be information of one or more of a calculus position, a calculus shape, a calculus gray-scale value, a long diameter and a short diameter corresponding to the calculus, a calculus area, and a calculus volume.

5. The method of claim 1, further comprising: if the dual-energy abdominal image is configured to be a three-dimensional dual-energy abdominal CT image, then identifying, on the basis of an atomic number image of a urinary calculus corresponding to the dual-energy abdominal image, a corresponding calculus type of corresponding calculus information extracted on the basis of the dual-energy abdominal image and/or the calculus mask image.
